(19) United States
(12) Patent Application Publication
(10) Pub. No.: US 2015/0261724 A1
(43) Pub. Date: Sep. 17, 2015

(54) MASSIVE PARALLEL EXASCALE STORAGE SYSTEM ARCHITECTURE

(71) Applicant: Emilio Billi, San Jose, CA (US)

(72) Inventor: Emilio Billi, San Jose, CA (US)

(21) Appl. No.: 14/214,588

(22) Filed: Mar. 14, 2014

(51) Int. Cl. G06F 15/80

(52) U.S. Cl. CPC G06F 15/80

(57) ABSTRACT

An high performance, linearly scalable, massive parallel architecture for storage systems comprises a plurality of simple individual storage nodes containing at least one CPU one storage element and, at least, one interconnection fabric link tightly connected together using a multidimensional high performance high scalable interconnection network fabric, preferably based on a PCIe dNTB architecture, organized, preferably, in an multidimensional hypercube topology or in a multidimensional Hypercubes derived topology.

### CROSS REFERENCE TO RELATED APPLICATIONS

The present application is a continuation-in-part of co-pending U.S. Patent application No. 61/786,560, entitled “Massive Parallel Petabyte Scale Storage System Architecture”, filed Mar. 15, 2013.

### BACKGROUND OF THE INVENTION

1. Field of Invention

The present invention is directed to an interconnection driven massively scalable storage and storage/computing merged architecture that can efficiently deliver linear scalability in capacity, bandwidth and input output per seconds (IOPS), from small to for peta-scale and greater level storage systems. wherein that architecture the disks and the storage nodes are organized to became the core of the system, creating a storage entities that is able to scale linearly to 10000 s of units using an efficient interconnection mechanism in combination with an opportune inter nodes interconnection topology.

2. Description of Related Art

One of the most important problem with the existing storage architectures is that storage doesn't scale linearly. This seems counter-intuitive since it is so easy to simply purchase another set of disks to double the size of available storage. The caveat in doing so is that the scalability of storage has multiple dimensions, capacity being only one of them, the others are bandwidth and lOPS. High performance computing systems require storage systems capable of storing multiple petabyte of data and delivering that data to thousands of users with the maximum speed possible so the capacity is just one of the aspect but not the most important. Today the high performance computing is entered into many different applications, not only related to supercomputing but also into the standard datacenter operations like for example big data analytics applications. As high performance computers have shifted from a few very powerful computation elements to 1000 s of commodity computing elements, storage systems must make the same transaction from few high performance storage engines to thousands of networked storage entities done using commodity type storage devices. This strategic transition must be done considering a shift in the design paradigm of storage nodes. New analytic application markets need a completely new view of how storage architecture should be done. The focus must become the “storage entity” that include the storage devices, at least one CPU for the local management and local computation and the network interfaces for the storage synchronization and for the user access. This “storage entity” is the new focus on the storage architecture, not anymore only the disk drives and shelves. This implies a new level of independence, which guarantees orders of magnitude of better performance, scalability, manageability, and reliability never before seen in any other storage system, with opportunities for integration at the application level like for example in massively parallel analytic applications. In other words the architectural focus must shift from the elementary storage elements(disks, PCIe SSDs cards or other storage devices available on the market present and future), to the entire storage node that can be comprised of disks, SSDs, CPUs and I/O interfaces and that become equivalent to the processing elements in massively parallel computers.

There are many existing techniques that provide high bandwidth service in storage, including RAID, traditional storage area networks and network attached storage. However, these techniques cannot provide more than 100 Giga byte of bandwidth on their own, and each has limitations manifest in a petabyte-scale storage system and larger. We need to think in parallel on all the aspect of the storage architecture itself, parallel set of disks, parallel CPUs for distributed management, multiple 10 interfaces distributed across the storage entity for the user to access in parallel way to the storage its self. On the contrary, network topologies developed for massively parallel computers can be used to build the data plane that synchronize and realize the parallelism in the file system operations providing the right speed to realize a new kind of massively parallel storage systems with scalable user bandwidth and lOPS with no bottlenecks.

Other than that, the idea to create scale out storage to permit to the storage to scale linearly is limited too. Today scale out storage system are often realized with software-based solution, called in many case as software defined storage. This solutions use, in most of the cases, the user network and the datacenter network for all the activities like, but not limited to, access to the data, write the data, manage the storage, move the date between different storage nodes. All the activities related to the storage activity generates high overhead in the network itself and limiting the real scalability in performance of the system.

There is a need in the art for a completely new view of how computational power and data storage are connected and organized.

There is also the need in the art for a storage architecture that can scale in capacity and performance linearly without introducing bottlenecks in terms of I/O capability.

### SUMMARY

Embodiments of the invention provide an alternative architecture for storage systems. This architecture can be applied successfully from small system to parallel storage systems built starting from individual nodes interconnected together using a dedicated high performance, low latency high scalable fabric. This fabric is used, in the system, as storage data plane fabric. A secondary network interface, different from the storage one is used as user network to access to the storage its self from the external world in order to realize multiple concurrent access points to the system.

In one aspect, embodiments of the invention relates to a storage node architecture designed to be interconnect with a dedicated fabric in a highly scalable way realized starting form a computing nodes equipped with a pull of solid state hard drive and one or more external interfaces that provides the connectivity with the rest of the world. This configuration can be considered the perfect storage node.

In some embodiments, 1000 s of these storage nodes are organized in a massively parallel architecture and interconnected in a dense xD multi-dimensional array in order to create a fast scalable storage system with 1000 s of Giga Byte of I/Os bandwidth with overall performance of billions of lOPS.

### BRIEF DESCRIPTION OF THE DRAWINGS

FIG. 1. Shows, in a preferred embodiment, the architecture of the storage node with the integrated fabric switch.

FIG. 2 Shows, in a preferred embodiment, a possible realization of the storage system proposed based on a hypercube based network topology for the internal data plane network.

FIG. 3 Shows the organization of the system and its integration with a datacenter or user network.

### DETAILED DESCRIPTION OF THE PREFERRED EMBODIMENTS

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

Most of the current design for scale-out storage systems rely upon relatively large individual storage systems that must be connected by at least a single very high-speed, high bandwidth interconnections in order to provide the needed bandwidth for the users and provide the required transfer bandwidth to each storage element. The present invention provides an alternative to this design technique using a dedicated fabric network that can be used in combination with a multi-dimensional topology capable of a distributed non transparent switching architecture used to interconnect each single storage node. This approach provide better bandwidth and scalability that the traditional one using a less network bandwidth per single network channel, resulting in a less expensive architecture

A modern scale-out storage system must provide high bandwidth, have low latency in data access, must be continuously available, must not lose data, and its performance must scale as its capacity scales. Existing large scale storage systems have some of these features but not all of them. This situation is not acceptable in an environment where big data set data are need to be continuously, efficiently and quickly available for intensive processing.

In the present invention we introduce the concept of an architecturally simplified storage node where the inside storage capacity can be relatively small. These storage nodes are connected together in a parallel way using a dedicate data plane. Each of these node provide at least one secondary network interface that is use for external connectivity, like for example, but not limited to, datacenter connectivity, pr external commuting nodes connectivity. With this architecture in mind 1000 s and more of these nodes can be densely connected together using multidimensional network topologies, like e.g. but not limited to Hypercubes, 2D torus or 3D torus, introducing the concept of massively parallel distributed storage architecture as new way to build efficient storage systems.

In general, one petabyte of storage capability can be achieved, with this approach, using e.g. 2048 elements with 512 GB of capacity each or e.g. 8192 elements of 128 GB each. If these storage units are organized in a multidimensional parallel array, closely interconnected together, with each single node-to-node link channel capable of a real bandwidth of 1.4 Gbyte/s, they could deliver respectively 700 Giga Byte per seconds with more than 40 Mega IOPS and more than 11 Terabytes per second of bandwidth and more than 0.6 Giga IOPS, using standard PCIe SSDs. Copy of the single data could also be distributed on multiple discrete nodes creating a high level of data redundancy where if a single entire node failed, data would still be available in another node.

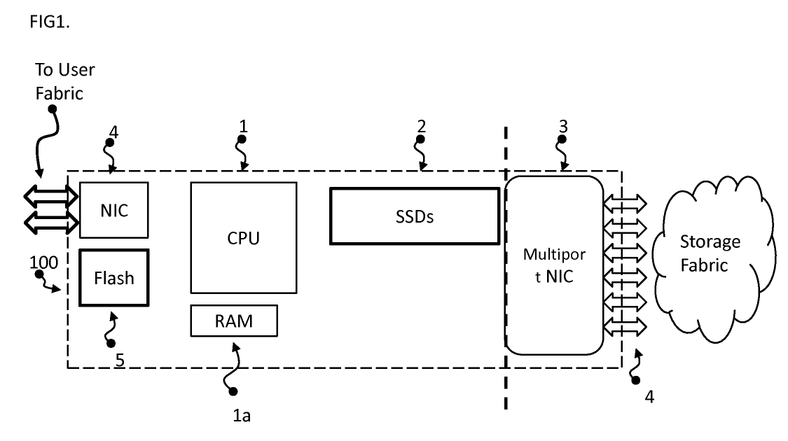

FIG. 1. Shows, in a preferred embodiment, the architecture of a possible storage node. The storage node comprises at least a main board 100 with inside: a CPU (1), a least one, single or multi-core, with its local RAM memory (1a), at least one disk (2), for example, but not limited to, PCIe, SAS or SATA SSDs or other equivalent devices, at least single or multiport network interface controller (3), used to connect other storage nodes through the storage fabric (101), at least a supplementary network interface controller NIC (4) used for user external (datacenter or user) connections. The CPU (1) is equipped with a dedicated embedded flash (5) or other boot capable devices, like, for example, a dedicated disk, that is used for system boot and initialization. The elements (1), (2), (3), (4) can be combined, entirely or in part, in a single system on chip using dedicate ASIC, FPGAs.

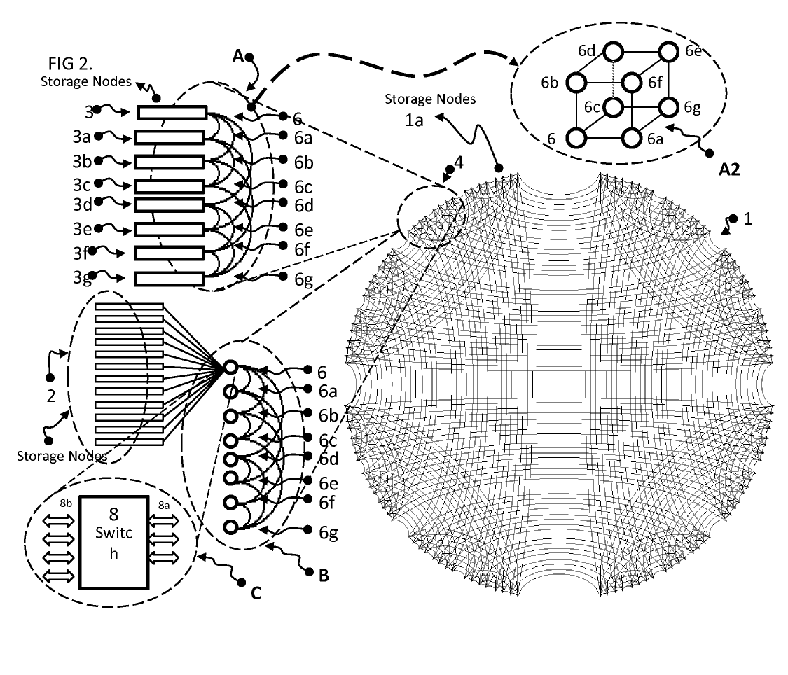

FIG.2 Shows, in a preferred embodiment, a possible realization of the storage system proposed based on a data plane realized in hypercube network topology. The choice of the Hypercube topology and any related hypercube derived topologies is due to the topological properties of the Hypercube that fits very well with the goal of the proposed storage architecture. The n-dimensional hypercube is a highly concurrent loosely coupled multiprocessor based on the binary n-cube topology. Machines based on the hypercube topology have been considered as ideal parallel architectures for their powerful interconnection features. More in detail the hypercube interconnection (1) is used to connect all the storage element nodes (n1a) together. The hypercube is logically composed by many basic groups (4) according with the Hypercubes mathematical description and each of this group is represented, in that example, but not limited to, by a multiport fabric switch (8). Each of these multi-port switches represents a hypercube vertex. Each of these multiport switches has the same number of fabric ports used to connect together other switches, inside the fabric, creating the network; the number of ports is strictly related with the hypercube topological dimension. According with the literature for an Hypercube we have N (number of vertex)=2̂ In(number of network links) that for example means that a 64 vertex Hypercube require 6 network links per vertex. One of the ports of the switch is used to connect the storage node using an opportune local interface. These switches can be embedded into the storage node as showed in the detail (A). In this way, a single storage node represents each hypercube vertex. In a different embodiment, each single vertex of the hypercube is composed of an external switch that is used to connect multiple nodes together as shown in the detail (B). In this case each single vertex of the hypercube is represented by an independent switch that is used to connect at least one single storage node to the hypercube based fabric. In detail, the group (A) shows an hypercube group composed by the hypercube vertex (6a),(6b),(6c),(6d),(6e),(6f),(6g) organized as 3D cube (2̂3 Vertex), as shown in detail (A2). Each vertex is directly connected to a single storage node. The storage node (3a) is connected to the vertex (6a), the storage node (3b) is connected to the vertex (6b) and so on. Each storage node is connected with the other nodes in the group using a point-to-point connection. The detail (B) shows how a different organization of the storage nodes can be created using multiple switches connected to the hypercube vertex instead of using the direct connection between the vertex and the storage node as described in the detail (A). In this case the hypercube group (B) has many external switch connections to each hypercube vertex group (6a),(6b),(6c),(6d),(6e),(6f),(6g). One switch per single vertex of the hypercube. Each switch has multiple ports for hypercube fabric connection (8a) and multiple ports (8b) that are used to connect the storage nodes (2). The detail (C) show how these switches can be organized. The switch (8), has n ports (8a) dedicated to the connection with the hypercube fabric , and has x ports (8b) dedicated to the connection with the storage nodes. Note that number x can be different from number n. The main advantage of this configuration is the lower cost and the major flexibility of the final storage architecture compared with the solution described by the detail (A). Other topologies can be used to achieve the same level of parallelism like, but not limited to, k-ary d-cube topologies and derivate. Each of the storage nodes have at least secondary interface that is used for the external connectivity.

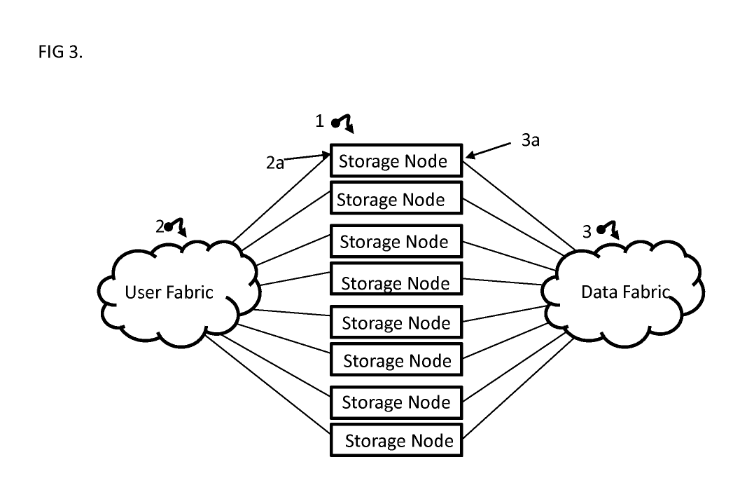

FIG. 3. Represent, conceptually, how the storage system can be connected on the existing environment. Multiple storage nodes (1) are connected together using the storage data plane fabric (3) by the, dedicated, network interface (3a). The resulting system is connected to the external world using the user fabric (2) by the, dedicated, network interface (2a). The advantages of this architecture is the complete separation from the user network and the storage data plane. This implementation permit to off load the user fabric from the operation related to the storage organization and permit to achieve a linear scalability in terms of access bandwidth to the system.

1. An high performance, linearly scalable, massive parallel architecture for parallel storage systems comprised of simple individual storage nodes containing at least one CPU, one storage element, at least one interconnection fabric link, for the node interconnection, and at least one network interconnection interface for the user connectivity to the system, where the nodes are tightly connected together using a high performance high scalable interconnection network fabric.

2. An high performance, linearly scalable, massive parallel architecture for parallel storage systems of claim 1 wherein the storage node has integrated the fabric switch.

3. An high performance, linearly scalable, massive parallel architecture for parallel storage systems where the storage nodes are connected together using multidimensional topologies like, but not limited to, Hypercubes and each single storage node is equipped with at least one secondary network interface used for the user connectivity to the system.

4. An high performance, linearly scalable, massive parallel architecture for parallel storage systems as described in the claim 3 where the node is used for computation and storage at the same time realizing a massive parallel computing merged architecture dedicated to , but not limited to, analytic operations or intense scientific and data applications.
